(19) United States
(12) Patent Application Publication
(10) Pub. No.: US 2017/0347779 A1
(43) Pub. Date: Dec. 7, 2017

(54) Belt Buckle with a Removable Electronic Device

(71) Applicant: Bahram Sobbi, Calgary (CA)

(72) Inventor: Bahram Sobbi, Calgary (CA)

(21) Appl. No.: 15/175,523

(22) Filed: Jun. 7, 2016

(51) Int. Cl. A45F 5/02; H04B 1/3888

(52) U.S. Cl. CPC A45F 5/021; H04B 1/3888

(57) ABSTRACT

A cellular device belt buckle includes a buckle plate having a front side, a back side, a belt tongue, a belt pin extending outwardly from the back side, a pair of confronting dog ears extending outwardly from the front side, and a pair of spring tabs. The cellular device belt buckle further includes a cell phone having a pair of slots extending through a side end and a pair of apertures formed through an attachment face formed of the cell phone. The cell phone is removably attached to the front side of the buckle plate with the spring tabs cooperatively engaged with the slots and the dog ears cooperatively engaged with the apertures.

### FIELD OF THE INVENTION

The present invention relates generally to belt buckles and personal electronic devices, and more particularly, relating to a belt buckle with a removable personal electronic device.

### BACKGROUND OF THE INVENTION

Conventionally, portable electronic devices, i.e. cellular phones, are configured to be received by a case that is configured to be attached to a user worn belt. Additionally, it is known to configure a portable electronic device to be worn as belt buckle. While existing cellular phone designs fulfill their respective, particular objectives and requirements, the need remains for an improved cellular phone that is removably attached to a belt buckle plate that a cellular phone can be attached to and removed from without unbuckling the belt buckle.

### SUMMARY OF THE INVENTION

In view of the foregoing disadvantages inherent in the known types of cellular devices including devices now present in the prior art, the present invention provides a new cellular device belt buckle construction having a cell phone, which can be removed from a belt buckle without decoupling the belt buckle from the waist belt.

In general, in one aspect, a cellular device belt buckle is provided. The cellular device belt buckle includes a cell phone having a pair of slots extending through a side end and a pair of apertures formed through an attachment face of the cell phone. The cellular device belt buckle further includes a buckle plate having a front side, a back side, a belt tongue, a belt pin extending outwardly from the back side, a pair of confronting dog ears extending outwardly from the front side, and a pair of spring tabs. The cell phone is removably attached to the front side of the buckle plate with the spring tabs cooperatively engaged with the slots and the dog ears cooperatively engaged with said apertures. The cellular device belt buckle further includes a space where at least one credit card is stored between the cell phone and the buckle plate.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective view of a belt buckle with a removable electronic device that is constructed accordance with the principles of an embodiment of the present invention, illustrating the belt buckle attached to a waist belt and the electronic device attached to the belt buckle;

FIG. 2 is a perspective view of a belt buckle with a removable electronic device that is constructed accordance with the principles of an embodiment of the present invention, illustrating belt buckle attached to a waist belt and the electronic device disconnected from the belt buckle;

FIG. 3 is a front elevation view of an electronic device that is constructed accordance with the principles of an embodiment of the present invention;

FIG. 4 is a rear perspective view of an electronic device that is constructed accordance with the principles of an embodiment of the present invention;

FIG. 5 is a front perspective view of a belt buckle with a removable electronic device that is constructed accordance with the principles of an embodiment of the present invention, illustrating the belt buckle unattached to a waist belt and the electronic device attached to the belt buckle;

FIG. 6 is a front view of a belt buckle with a removable electronic device that is constructed accordance with the principles of an embodiment of the present invention, illustrating the belt buckle unattached to a waist belt and the electronic device attached to the belt buckle;

FIG. 7 is a cross-sectional view of the belt buckle with a removable electronic device taken along line 7-7 in FIG. 6, showing a cooperative engagement between the electronic device and a buckle plate of the belt buckle and a credit card removably disposed within a space between the electronic device and the buckle plate;

FIG. 8 is a cross-sectional view of the belt buckle with a removable electronic device taken along line 8-8 in FIG. 6, further showing a cooperative engagement between the electronic device and the buckle plate and the credit card disposed between the cell phone and the buckle plate;

FIG. 9 is a front perspective view of a buckle plate, shown with the electronic device detached;

FIG. 10 is a top view of a buckle plate;

FIG. 11 is front view of a buckle plate; and

FIG. 12 is a side view of a buckle plate.

### DETAILED DESCRIPTION OF THE INVENTION

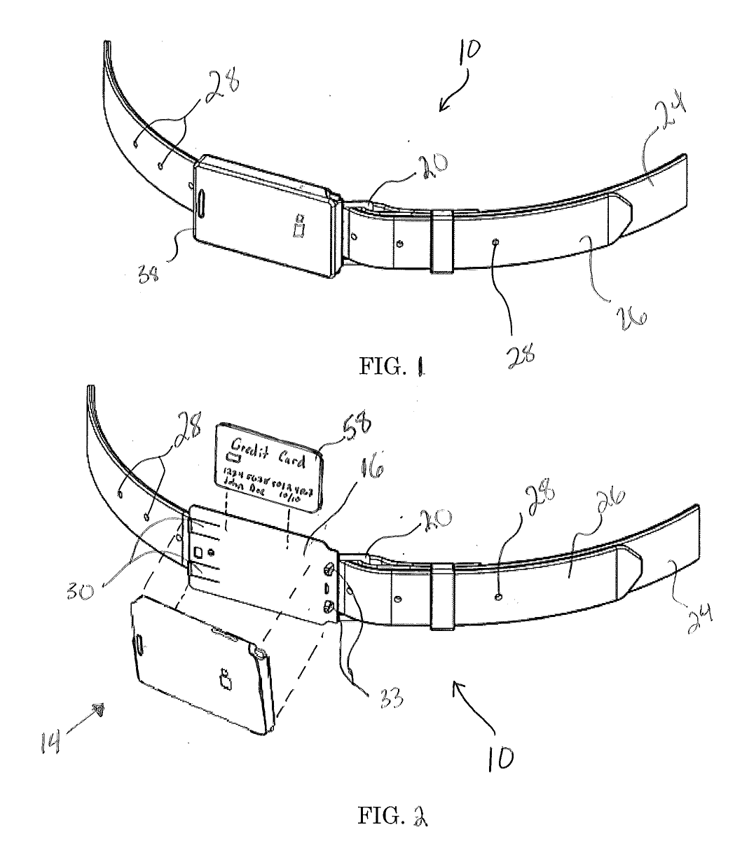

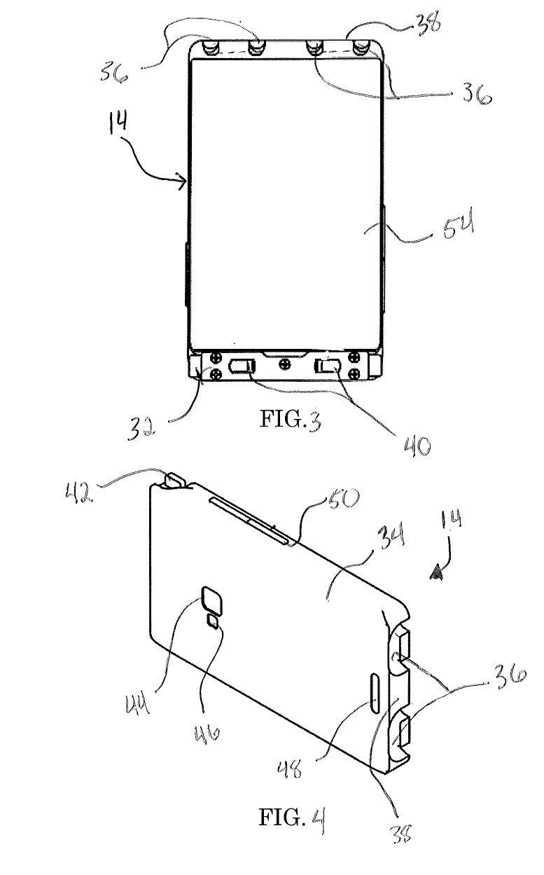

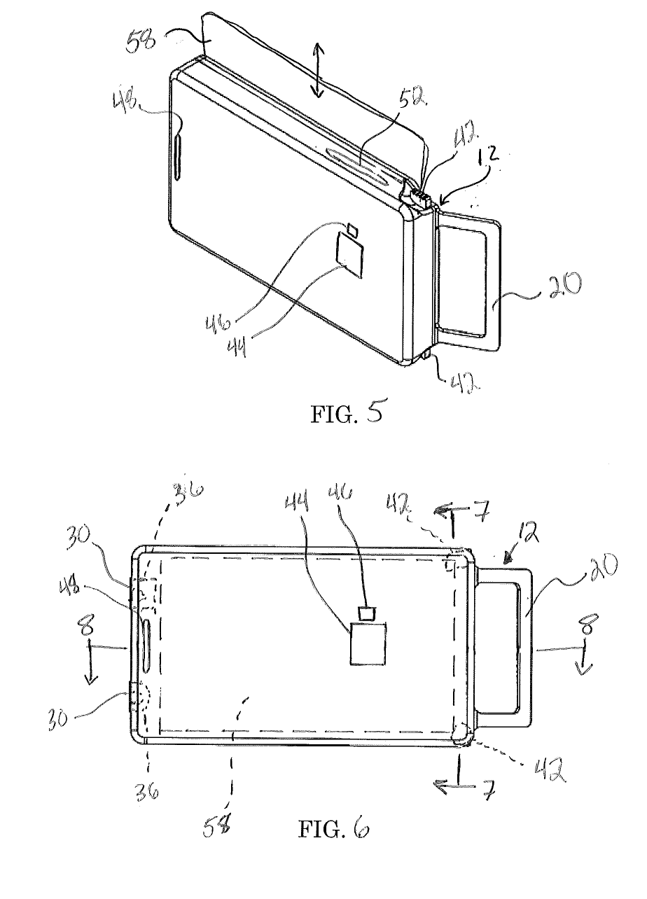

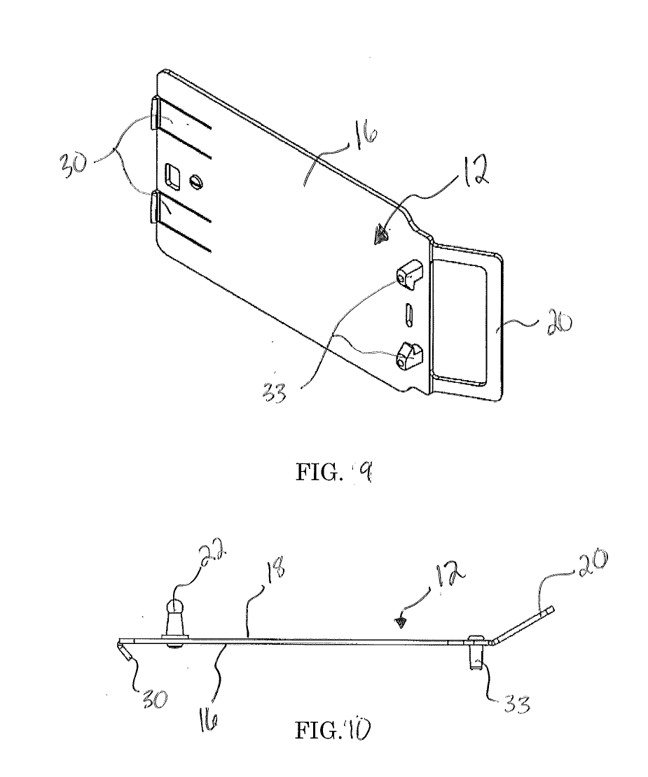

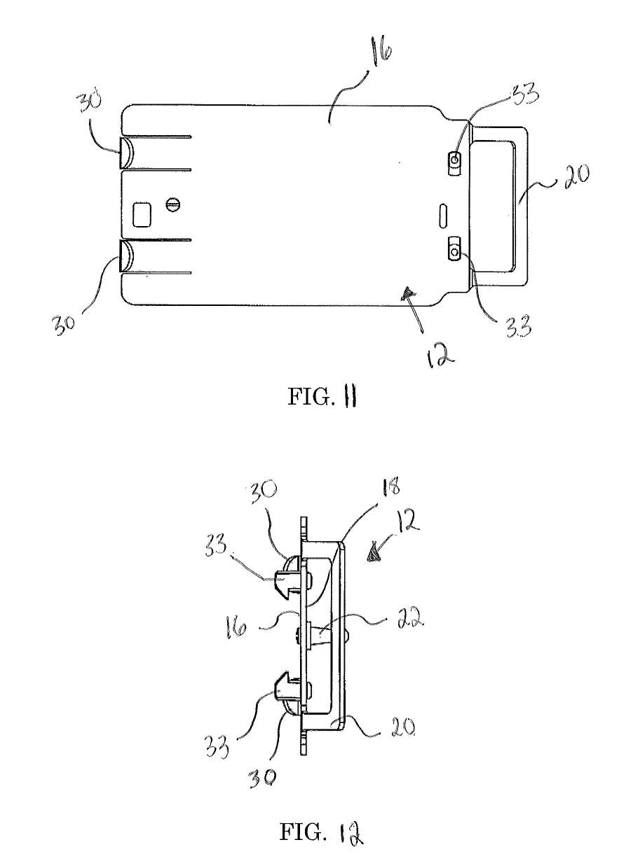

With reference now to the drawings, and in particular FIGS. 1 through 12 thereof, a belt buckle with a detachable electronic device that is constructed in accordance with an embodiment of the present invention and generally designated by the reference number 10 will be described.

The belt buckle with a detachable electronic device 10 includes a buckle plate 12 and an electronic device 14 that is configured to be removably attached to and supported by the buckle plate 12. The buckle plate 12 is comprised of substantially rigid plate having front and back sides 16 and 18, respectively. And, while the buckle plate 12 is shown flat, it could be slightly curved. The buckle plate can also be made of any suitable material, such as, for example, metal or plastic.

The buckle plate 12 further includes a waist belt attachment tongue 20 and a belt pin 22 extending outwardly from the back side 18 thereof. As best seen in FIGS. 1 and 2, the buckle plate 12 is connected, for use, to a waist belt 24 in a conventional manner by looping one end of the waist belt 24 over and through the tongue 20. The opposite end of the waist belt 26 is conventionally secured by extending belt pin 22 through anyone of the corresponding pin holes 28 that extend along the waist belt.

Additionally, the buckle plate 12 includes a pair of spring tabs 30 at the end opposite of the tongue 20, and a pair of confronting dog ears 33 that extend outwardly from the front side 16 and approximate the tongue 20.

Electronic device 14, representatively shown and described as a cellular phone has a front side 32 and a back side 34. The cellular phone 14 is configured to be cooperatively connected to the front side 16 of the buckle plate 12 with the front side 32 of the cellular phone facing the front side of the buckle plate 12. The cellular phone 14 includes slots 36 extending through side end 38 and apertures 40 extending through the front side 32 at a position opposite of side end 38. Slots 36 are arranged to cooperatively engage with spring tabs 30 and apertures 40 are arranged to cooperatively engage with dog ears 33 when the cellular phone 14 is positioned on the front side 16 of the buckle plate 12.

More specifically, the cellular phone 14 is removably attached to the front side 16 of the buckle plate 12 by inserting the spring tabs 30 into corresponding slots 36 formed through side end 38 of the cellular phone 14. And aligning and inserting dog ears 33 into corresponding apertures 40 disposed on the front side 32 of cellular phone 14. Each dog ear 33 is retained in its respective aperture 40 by a catch 42 that is spring biased, and pressing inwardly on the catch 42 releases the dog ear 33 and permits withdrawing the dog ear from its respective aperture 40. To this end, an important aspect of the present invention is the ability to detach or remove the cellular phone 14 from the buckle plate 12 without decoupling the buckle plate from the waist belt 24.

The cellular phone 14 further includes a camera 44, a light source 46, and an external speaker 48 disposed along the back side 34. A volume control button 50 and a screen lock button 52 each located along opposed side edges of cellular phone 14. A display screen, such as a touch screen 54 is disposed on the front side 32. The cellular phone 14 is configured to operate in the same way as a conventional cellular device, wherein the user may control each feature of the cell phone by touching the display and the included buttons on the device.

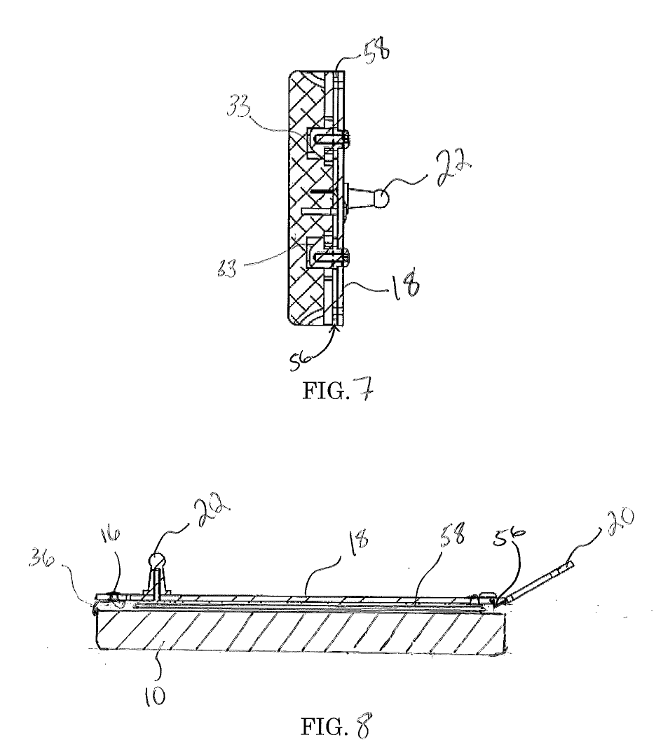

When the cellular phone 14 is attached to the buckle plate 12, the front side 32 of cellular phone 14 is spaced a distance from the front side 16 of the buckle plate 12 forming a space 56 that is sufficiently sized to removably receive a credit card 58 therewithin, as best seen in FIG. 8.

A number of embodiments of the present invention have been described. Nevertheless, it will be understood that various modifications may be made without departing from the spirit and scope of the invention. Accordingly, other embodiments are within the scope of the following claims.

What is claimed is:

1. A belt buckle and electronic device, comprising:
an electronic device having front side, a side end, a pair of slots extending said side end and a pair of apertures formed through said front side;
a buckle plate having a front side, a back side, a belt tongue, a belt pin extending outwardly from said back side, a pair of confronting dog ears extending outwardly from said front side, and a pair of spring tabs;
wherein said electronic device is removably attached to said buckle plate with said spring tabs cooperatively engaged with said slots and said dog ears cooperatively engaged with said apertures; and
wherein when said electronic device is attached to said buckle plate said front side of said electronic device is spaced a distance from said front side of said buckle plate forming a space therebetween, said space being sufficient sized so as to removably receive a credit card therewithin.

2. The belt buckle and electronic device of claim 1, wherein said dog ears are removably retained in a respective aperture by a spring biased catch.

3. The belt buckle and electronic device of claim 1, wherein said electronic device substantially overlaps said buckle plate.

4. The belt buckle and electronic device of claim 1, wherein said pair of spring tabs are disposed at a side of said buckle plate opposite of said belt tongue.

5. The belt buckle and electronic device of claim 1, wherein said electronic device is a cellular telephone.

6. The belt buckle and electronic device of claim 5, wherein said cellular phone includes a display screen, an external speaker, a camera, a light source, a screen lock button, and a volume control button.
